(19) United States
(12) Patent Application Publication
(10) Pub. No.: US 2025/0284960 A1
(43) Pub. Date: Sep. 11, 2025

(54) METHOD, DEVICE, AND COMPUTER-READABLE STORAGE MEDIUM FOR ROBUST MULTIMEDIA RECOMMENDATION BASED ON INFORMATION BOTTLENECK

(71) Applicants: Hefei University of Technology, Hefei (CN); Anhui Wuyou Technology Co., Ltd., Hefei (CN)

(72) Inventors: Le WU, Hefei (CN); Yonghui YANG, Hefei (CN); Kun ZHANG, Hefei (CN); Richang HONG, Hefei (CN); Meng WANG, Hefei (CN); Hailin ZHOU, Hefei (CN); Wenzheng CHENG, Hefei (CN)

(21) Appl. No.: 19/213,687

(22) Filed: May 20, 2025

Related U.S. Application Data
(63) Continuation of application No. PCT/CN2024/118410, filed on Sep. 12, 2024.

(30) Foreign Application Priority Data
Oct. 18, 2023 (CN) 202311351239.9

(51) Int. Cl. G06N 3/084; G06F 18/213; G06N 3/042

(52) U.S. Cl. CPC G06N 3/084; G06F 18/213; G06N 3/042

(57) ABSTRACT

A robust multimedia recommendation method based on information bottleneck, including: a user representation matrix and an item representation matrix are learned based on a deep graph neural model; mutual information between multimedia content and representation information of the multimedia content is minimized based on an information bottleneck theory to compute a first loss function; a user-item interaction matrix is reconstructed based on the user representation matrix and the item representation matrix to compute a second loss function; and the first loss function and the second loss function are combined to perform multi-task learning to update parameters of the deep graph neural model until the deep graph neural model converges. A robust multimedia recommendation device and a robust multimedia recommendation medium are further provided.

### CROSS-REFERENCE TO RELATED APPLICATIONS

This application is a continuation of International Patent Application No. PCT/CN2024/118410, filed on Sep. 12, 2024, which claims the benefit of priority from Chinese Patent Application No. 202311351239.9, filed on Oct. 18, 2023. The content of the aforementioned application, including any intervening amendments thereto, is incorporated herein by reference in its entirety.

### TECHNICAL FIELD

This application relates to multimedia recommendation, and more particularly to a method, a device, and a computer-readable storage medium for robust multimedia recommendation based on information bottleneck.

### BACKGROUND

Recommendation system is an individuation service technology and is commonly used to alleviate information overload brought by massive data. The traditional identity (ID)-based collaborative filtering method portrays user preferences through matrix decomposition or graph neural networks to achieve individuation recommendation of items. With the development of deep learning and multimedia information processing technology, multimedia data-assisted recommendation methods have been widely studied.

In related technologies, multimedia recommendation systems can use pre-training models to extract features from multimedia content and combine the features with ID information for user preference modelling. Since the pre-training model is usually task-oriented, for example, the visual pre-training model is trained based on the visual task, the extracted visual feature information has noisy information for the recommendation task, the quality of user preference modelling is poor, and the accuracy of multimedia recommendation is not satisfactory.

### SUMMARY

In view of the deficiencies of the prior art, this application provides a method, a device, and a computer-readable storage medium for robust multimedia recommendation based on information bottleneck, which solves the problem of inaccurate multimedia recommendation due to the presence of feature noise.

Technical solutions of this application are described as follows.

In a first aspect, this application provides a robust multimedia recommendation method based on information bottleneck, comprising:
(S1) constructing heterogeneous data comprising a user-item interaction matrix and multimedia content data of an item;
(S2) extracting a multimedia content feature of the item from the multimedia content data using a pre-training model;
(S3) constructing an item association matrix based on the multimedia content feature;
(S4) learning a user representation matrix and an item representation matrix based on a deep graph neural model;
(S5) minimizing, based on an information bottleneck theory, mutual information between the multimedia content feature and representation information of the multimedia content feature to compute a first loss function;
(S6) reconstructing the user-item interaction matrix based on the user representation matrix and the item representation matrix to compute a second loss function; and
(S7) combining the first loss function and the second loss function to perform multi-task learning to update parameters of the deep graph neural model until the deep graph neural model converges.

In an embodiment, step (S1) comprises:
(1.1) denoting a user set by U, wherein U={u₁, . . . uₐ, . . . , u_{b}, . . . u_{M}}; uₐ represents an a-th user; u_{b} represents a b-th user; and M represents the number of users, and 1≤a, b≤M;
denoting an item set by V, wherein V={v₁, . . . , vᵢ, . . . , vⱼ, . . . , v_{N}}; vᵢ represents an i-th item; vⱼ represents a j-th item; and N represents the number of items, and 1≤i, j≤N;
denoting interaction data between the a-th user uₐ and the i-th item vᵢ by rₐᵢ such that the user-item interaction matrix is represented by R={rₐᵢ}_{M×N}; and
(1.2) denoting multimedia content of the item set V by C, wherein C={C¹, . . . , C^{k}, . . . , C^{K}}; C^{k} represents multimedia content of a k-th modal in the item set V, C^{k}={c₁^{k}, . . . , cᵢ^{k}, . . . , c_{N}^{k}}; cᵢ^{k} represents multimedia content of a k-th modal of the i-th item vᵢ, and K represents the number of modals, and 1≤k≤K;
step (S2) comprises:
(2.1) performing feature extraction on multimedia content of each of K modals by using a corresponding pre-training model to obtain a multimedia feature matrix set {F¹, . . . , F^{k}, . . . , F^{K}} of the K modals, wherein F^{k} represents a multimedia feature matrix of the k-th modal;
step (S3) comprises:
(3.1) calculating a similarity matrix set {S¹, . . . , S^{k}, . . . , S^{K}} of the K modals in the item set V according to formula (1), expressed as:

$${S}^{k} = {L}_{2} ( {F}^{k} ) \times {( {L}_{2} ( {F}^{k} ) )}^{T} ; \qquad ( 1 )$$

wherein S^{k} represents a similarity matrix of the k-th modal in the item set V; L₂(F^{k}) represents a normalized multimedia feature matrix of the k-th modal in the item set V; and T represents matrix transpose;
(3.2) performing sparsification on the similarity matrix set {S¹, . . . , S^{k}, . . . , S^{K}} to obtain an association matrix set {S′¹, . . . , S′^{k}, . . . , S′^{K}} of the K modals in the item set V according to formula (2), expressed as:

$${s}_{i j}^{′ k} = \{ \begin{matrix}{s}_{ij}^{k} , & {s}_{i j}^{k} ∈ {TopK}^{′} ( {s}_{a}^{k} ) \\ 0 , & else\end{matrix} ; \qquad ( 2 )$$

wherein sᵢⱼ^{k} represents an element at a i-th row and a j-th column in the similarity matrix S^{k}; s′ᵢⱼ^{k} represents an element at a i-th row and a j-th column in an association matrix S′^{k} of the k-th modal; sᵢ^{k} represents all elements at the i-th row in the similarity matrix S^{k}; and TopK′ represents first K′ elements in a descending order;
(3.3) calculating an association matrix S′ of the item set V according to formula (3), expressed as:

$${S}^{′} = {\sum }_{k = 1}^{K} {S}^{′ k} ; \qquad ( 3 )$$

and
(3.4) calculating a representation propagation matrix A according to formula (4), expressed as:

$$A = [ \begin{matrix}0 & R \\ {R}^{T} & {S}^{′}\end{matrix} ] ; \qquad ( 4 )$$

and
calculating a normalized representation propagation matrix Ã according to formula (5), expressed as:

$$\tilde{A} = {D}^{- \frac{1}{2}} {AD}^{- \frac{1}{2}} ; \qquad ( 5 )$$

wherein D represents a degree matrix of the representation propagation matrix A;
step (S4) comprises:
(4.1) randomly initializing the user representation matrix P={p₁, . . . , pₐ, . . . , p_{M}} using Gaussian distribution, wherein pₐ represents a (d₁+Kd₂)-dimensional representation vector of the a-th user uₐ; d₁ represents a user co-representation dimension; and d₂ represents a content representation dimension; and
randomly initializing an item co-representation matrix Q={q₁, . . . , qᵢ, . . . , q_{N}} using Gaussian distribution, wherein qᵢ represents a d₁-dimensional representation vector of the i-th item vᵢ;
(4.2) calculating a multimedia content representation matrix T=[T¹, . . . , T^{k}, . . . , T^{K}] of the K modals in the item set V according to formula (6), expressed as:

$${T}^{k} = {MLP}_{k} ( {F}^{k} ) ; \qquad ( 6 )$$

wherein MLPₖ represents a k-th multilayer perceptron; and T^{k}∈R_{N×d}_{₂} represents a multimedia content representation matrix of the k-th modal in the item set V; and
(4.3) constructing the item representation matrix E=[Q, T]; and processing {P, E} through a graph neural network to obtain a final user representation matrix H^{u} and a final item representation matrix H^{v};
step (S5) comprises:
(5.1) performing dimensionality reduction on the multimedia feature matrix set {F¹, . . . , F^{k}, . . . , F^{K}} by using a principal component analysis (PCA) algorithm, so as to obtain a dimensionality-reduced multimodal feature matrix {F′¹, . . . , F′^{k}, . . . , F′^{K}}; wherein F′^{k}∈R_{N×d}_{₂} represents a dimensionality-reduced matrix of the multimedia feature matrix F^{k}; and
(5.2) constructing an information bottleneck loss function according to formula (7), expressed as:

$$L ( {θ}_{1} ) = {\sum }_{k = 1}^{K} HSIC ( {F}^{′ k} , {T}^{k} ) ; \qquad ( 7 )$$

wherein θ₁ represents a parameter corresponding to K multilayer perceptrons; and HSIC(,) represents a Hilbert-Schmidt independence criterion;
step (S6) comprises:
(6.1) predicting an interaction probability rₐᵢ′ of the a-th user uₐ with respect to the i-th item vᵢ according to formula (8), expressed as:

$${r}_{a i}^{′} = δ ( {( {h}_{a}^{u} )}^{T} {h}_{i}^{v} ) ; \qquad ( 8 )$$

wherein δ represents a sigmoid activation function; hₐ^{u} represents a transpose of a representation vector in an a-th row of the final user representation matrix H^{u}; and hᵢ^{v} represents a representation vector in an i-th row of the final item representation matrix H^{v}; and
(6.2) calculating a reconstruction loss function L (θ₂) according to formula (9), expressed as:

$$L ( {θ}_{2} ) = {\sum }_{a = 1}^{M} {\sum }_{( i , j ) ∈ {D}_{a}} ln δ ( {( {h}_{a}^{u} )}^{T} {h}_{j}^{v} - {( {h}_{a}^{u} )}^{T} {h}_{i}^{v} ) ; \qquad ( 9 )$$

wherein θ₂ represents parameters involved in reconstructing the interaction matrix, θ₂=[P, Q, θ₁]; Dₐ represents training data of the a-th user uₐ, and Dₐ={(i, j)|i∈Rₐ, j∈V−Rₐ}; Rₐ represents an interactive item set of the a-th user uₐ; and hⱼ^{v} represents a vector in a j-th row of the final item representation matrix H^{v};
step (S7) comprises:
(7.1) establishing a multitask optimization objective L(θ) according to formula (10), expressed as:

$$L ( θ ) = L ( {θ}_{1} ) + α L ( {θ}_{2} ) + β {‖ [ P , Q , ] ‖}^{2} ; \qquad ( 10 )$$

wherein θ=[P, Q, θ₂] represents to-be-optimized parameters; and α and β are configured to regulate a weight of the reconstruction loss function and a weight of a regularization term, respectively;
(7.2) solving the multitask optimization objective L(θ) by using a gradient descent method to update a parameter θ until L(θ) converges to a minimum value, so as to obtain an optimal parameter θ*; and
(7.3) predicting an optimal interaction probability rₐᵢ* of the a-th user uₐ with respect to the i-th item vᵢ according to formula (11), thereby obtaining a predicted interaction matrix R*={rₐᵢ*}_{M×N} of the user set U with respect to the item set V to achieve item recommendation, wherein the formula (11) is expressed as:

$${r}_{a i}^{*} = δ ( {( {h}_{a}^{u *} )}^{T} {h}_{i}^{v *} ) ; \qquad ( 11 )$$

wherein hₐ^{u}* represents an optimal representation vector of the a-th user uₐ; and hᵢ^{v}* represents an optimal representation vector of the i-th item vᵢ.

In an embodiment, in step (4.3), the graph neural network has L convolutional layers, and a current convolutional layer is denoted by l, and is initialized to be 0; and
the final user representation matrix H^{u} and the final item representation matrix H^{v} are constructed through the following steps:
initializing a node representation matrix H^{l}={P, E} of a l-th convolutional layer;
inputting the node representation matrix H^{l}={P, E} into the graph neural network; and calculating a node representation matrix H^{l+1} of a (l+1)-th convolutional layer according to formula (12), expressed as:

$${H}^{l + 1} = \tilde{A} {H}^{l} ; \qquad ( 12 )$$

aggregating outputs of individual convolutional layers according to formula (13) to obtain a final node representation matrix H:

$$H = \frac{1}{L + 1} {\sum }_{l = 0}^{L} {H}^{l} ; \qquad ( 13 )$$

obtaining the final user representation matrix H^{u} and the final item representation matrix H^{v} according to formula (14), expressed as:

$${H}^{u} = H [ : M ] , {H}^{v} = H [ M : ] ; \qquad ( 14 )$$

wherein H[: M] represents 1-st to M-th rows of the final node representation matrix H; and H[M:] represents (M+1)-th to (M+N)-th rows of the final node representation matrix H.

In an embodiment, the step of constructing the heterogeneous data comprises:
obtaining an item set and a user set, wherein the item set comprises the multimedia content data, and the user set comprises a plurality of user data information corresponding to the multimedia content data;
determining a mapping relationship between a plurality of users in the user set and individual sub-data in the multimedia content data, so as to obtain a plurality of objective data to characterize an interaction relationship between the user set and the item set; and
constructing the user-item interaction matrix based on the plurality of objective data.

In an embodiment, the pre-training model comprises a plurality of sub-training models predetermined; and
the step of extracting the multimedia content feature of the item using the pre-training model comprises:
classifying a plurality of specific modals corresponding to the multimedia content data; and establishing a mapping relationship between the plurality of specific modals and the plurality of sub-training models; and
extracting, based on the mapping relationship, multimedia content features respectively corresponding to the plurality of specific modals in an item set through the plurality of sub-training models, thereby obtaining a plurality of multimedia feature matrices and a multimedia feature matrix set.

In an embodiment, the multimedia content data corresponds to a plurality of specific modals; and
the step of constructing the item association matrix based on the multimedia content feature comprises:
analyzing a similarity of the plurality of specific modals; and determining a plurality of similarity matrices corresponding to the plurality of specific modals and a similarity matrix set;
sparsifying and sorting the plurality of similarity matrices to obtain a target sequence in which a plurality of elements are sequentially arranged in a descending order; and
selecting first n elements from the target sequence to determine the item association matrix among a plurality of items and an association matrix set, wherein n is a predetermined value.
after constructing the item association matrix based on the multimedia content feature, the robust multimedia recommendation method further comprises:
determining the user-item interaction matrix as a first matrix subset, and transposing the first matrix subset to obtain a second matrix subset;
determining the item association matrix as a third matrix subset; and
constructing a first representation propagation matrix based on the first matrix subset, the second matrix subset, and the third matrix subset.

In an embodiment, after constructing the first representation propagation matrix, the robust multimedia recommendation method further comprises:
calculating a degree matrix of the first representation propagation matrix; and
normalizing the first representation propagation matrix by multiplying the first representation propagation matrix by the degree matrix to obtain a second representation propagation matrix.

In an embodiment, the step of learning the user representation matrix and the item representation matrix based on the deep graph neural model comprises:
randomly generating an initialized user representation matrix and an initialized item co-representation matrix via Gaussian distribution;
computing a multimedia content representation matrix of the item by using a predetermined multilayer perceptron;
fusing the initialized item co-representation matrix with the multimedia content representation matrix to determine the item representation matrix;
fusing the initialized user representation matrix with the item representation matrix to determine a 0^{th}-layer node representation matrix;
inputting the 0^{th}-layer node representation matrix into a predetermined graph neural network, and taking the second representation propagation matrix as an iterative coefficient to obtain a plurality of intermediate node representation matrices respectively corresponding to a plurality of convolutional layers in the predetermined graph neural network;
based on the number of the plurality of convolutional layers in the predetermined graph neural network, aggregating the plurality of intermediate node representation matrices and the 0^{th}-layer node representation matrix to obtain a final node representation matrix.

In an embodiment, the final node representation matrix H is expressed as:

$$H = \frac{1}{L + 1} {\sum }_{l = 0}^{L} {H}^{l} ; \qquad ( 15 )$$

wherein L is the number of the plurality of convolutional layers; l represents a current convolutional layer; and H^{l} represents a node representation matrix of a l-th convolutional layer.

In an embodiment, after obtaining the final node representation matrix, the robust multimedia recommendation method further comprises:
analyzing and extracting individual row vectors in the final node representation matrix to determine a final user representation matrix H^{u} and a final item representation matrix H^{v};
the final user representation matrix H^{u} is expressed as: H^{u}=H[: M];
wherein H[: M] represents 1-st to M-th rows of the final node representation matrix H; and
the final item representation matrix H^{v} is expressed as: H^{v}=H[M:];
wherein H[M:] represents (M+1)-th to (M+n)-th rows of the final node representation matrix H.

In an embodiment, the representation information of the multimedia content is a multimedia content representation matrix; and the first loss function is an information bottleneck loss function; and
the step of minimizing, based on the information bottleneck theory, mutual information between the multimedia content and the representation information of the multimedia content to compute the first loss function comprises:
performing dimensionality reduction on a multimedia feature matrix set using a PCA algorithm to obtain a dimensionality-reduced multimodal feature matrix; and
calculating, based on the information bottleneck theory, a Hilbert-Schmidt independence criterion between the dimensionality-reduced multimodal feature matrix and the multimedia content representation matrix to obtain the information bottleneck loss function.

In an embodiment, the information bottleneck loss function is expressed as:

$$L ( {θ}_{1} ) = {\sum }_{k = 1}^{K} HSIC ( {F}^{′ k} , {T}^{k} ) ; \qquad ( 16 )$$

wherein L(θ₁) represents the information bottleneck loss function; θ₁ represents a parameter corresponding to K multilayer perceptrons; HSIC(,) represents the Hilbert-Schmidt independence criterion; F′^{K} represents the dimensionality-reduced multimodal feature matrix; and T^{k} represents the multimedia content representation matrix.

In an embodiment, the second loss function is a reconstruction loss function; and
the step of reconstructing the interaction matrix based on the user representation matrix and the item representation matrix to compute the second loss function comprises:
processing the final user representation matrix and the final item representation matrix by using a predetermined sigmoid activation function; predicting an interaction probability of each user for the item to reconstruct the user-item interaction matrix; and
based on a plurality of predicted interaction probabilities and all parameters involved in reconstructing the user-item interaction matrix, calculating the reconstruction loss function.

In an embodiment, the heterogeneous data further comprises an item set; and the plurality of predicted interaction probabilities are expressed as:

$${r}_{a i}^{′} = δ ( {( {h}_{a}^{u} )}^{T} {h}_{i}^{v} ) ; \qquad ( 17 )$$

wherein rₐᵢ′ represents the predicted interaction probabilities; δ represents the sigmoid activation function; hₐ^{u} represents a transpose of a representation vector in an a-th row of the final user representation matrix H^{u}; and hᵢ^{v} represents a representation vector in an i-th row of the final item representation matrix H^{v};
the reconstruction loss function L(θ₂) is expressed as:

$$L ( {θ}_{2} ) = {\sum }_{a = 1}^{M} {\sum }_{( i , j ) ∈ {D}_{a}} ln δ ( {( {h}_{a}^{u} )}^{T} {h}_{j}^{v} - {( {h}_{a}^{u} )}^{T} {h}_{i}^{v} ) ; \qquad ( 18 )$$

wherein θ₂ represents the parameters involved in reconstructing the user-item interaction matrix and corresponds to the reconstruction loss function, and θ₂=[P, Q, θ₁]; P is the initialized user representation matrix; Q is the initialized item co-representation matrix; and θ₁ represents parameters corresponding to K multilayer perceptrons;
Dₐ represents all training data of the a-th user uₐ, and Dₐ={(i, j)|i∈Rₐ, j∈V−Rₐ}; Rₐ represents an interactive item set of the a-th user uₐ; V represents the item set; and hⱼ^{v} represents a vector in a j-th row of the final item representation matrix H^{v}.

In an embodiment, the first loss function is an information bottleneck loss function, and the second loss function is a reconstruction loss function; and
the step of combining the first loss function and the second loss function to perform multi-task learning to update parameters of the deep graph neural model until the deep graph neural model converges comprises:
establishing a multitask optimization objective function based on the information bottleneck loss function and the reconstruction loss function; wherein the multitask optimization objective function corresponds to to-be-optimized parameters;
solving the multitask optimization objective function by a gradient descent method to update the to-be-optimized parameters;
determining a corresponding parameter when the multitask optimization objective function converges to a minimum value, as an optimal parameter after updating the to-be-optimized parameters; and
based on the optimal parameter, separately predicting a target interaction probability of each user for the item to determine a target interaction matrix, so as to achieve item recommendation.

In an embodiment, the multitask optimization objective function is expressed as:

$$L ( θ ) = L ( {θ}_{1} ) + α L ( {θ}_{2} ) + β {‖ [ P , Q , ] ‖}^{2} ; \qquad ( 19 )$$

wherein θ=[P, Q, θ₂] represents the to-be-optimized parameters; P is an initialized user representation matrix; Q is an initialized item co-representation matrix; θ₂ represents all parameters corresponding to the reconstruction loss function; ∥[P, Q]∥² is a regularization term; and α and β are configured to regulate a weight of the reconstruction loss function and a weight of the regularization term, respectively;
the target interaction matrix is expressed as: R*={rₐᵢ*}_{M×N};
wherein rₐᵢ*=δ((hₐ^{u}*)^{T} hᵢ^{v}*); hₐ^{u}* represents a target representation vector of an a-th user uₐ; and hᵢ^{v}* represents a target representation vector of an i-th item vᵢ.

In a second aspect, this application provides an electronic device, comprising:
a processor;
a memory; and
a program stored on the memory and configured to be run on the processor;
wherein the program is configured to be executed by the processor to implement the robust multimedia recommendation method provided in the first aspect.

In a third aspect, this application provides a non-transitory computer-readable storage medium, wherein the non-transitory computer-readable storage medium stores a program; and the program is configured to be executed by a processor to implement the robust multimedia recommendation method provided in the first aspect.

Compared to the prior art, this application has the following beneficial effects.

The method provided in this application extracts multimedia content features of an item through a pre-training model to construct an item association matrix, and learns user and item representation matrices through a deep graph neural model without introducing any model parameters. The method is very lightweight and has strong practical value. An information bottleneck constraint is constructed through the information bottleneck theory. Mutual information between the multimedia content feature and its representation information is minimized to obtain the minimum multimedia content satisfying the recommendation task, and then the pre-training multimedia features are denoised, which can implicitly reduce the impact of multimedia noise on user modelling, thus improving the quality of user preference modelling and enhancing the recommendation performance.

### BRIEF DESCRIPTION OF THE DRAWINGS

In order to illustrate the embodiments of the present disclosure or the technical solution in the prior art more clearly, the drawings required in the description of the embodiments or the prior art will be briefly described below. Obviously, presented in the drawings are merely some embodiments of the present disclosure, which are not intended to limit the disclosure. For those skilled in the art, other drawings may also be obtained according to the drawings provided herein without paying creative efforts.

FIG. 1 is a flowchart of a robust multimedia recommendation method according to one embodiment of the present disclosure;

FIG. 2 is another flowchart of a robust multimedia recommendation method according to one embodiment of the present disclosure;

FIG. 3 is a flowchart of step (110) in FIG. 1 according to one embodiment of the present disclosure; and

FIG. 4 schematically shows a structure of an electronic device according to one embodiment of the present disclosure.

### DETAILED DESCRIPTION OF EMBODIMENTS

The technical solutions of the disclosure will be described clearly and completely to make the technical solutions, objects and advantages of the disclosure clearer. Obviously, described below are merely some embodiments of the disclosure, which are not intended to limit the disclosure. For those skilled in the art, other embodiments obtained based on these embodiments without paying creative efforts should fall within the scope of the disclosure defined by the appended claims.

In addition, the terms “first” and “second” are used only to distinguish one entity or operation from another, and cannot be understood as indicating or implying order or relative importance between these entities or operations. It should be understood that as used herein, the terms “include” and “comprise” indicate the presence of the described features, entireties, steps, operations, elements and/or components in a process, method, article, or device, but do not exclude the presence or addition of one or more other features, entireties, steps, operations, elements, components and/or a combination thereof. Unless otherwise specified, the phrase “includes a . . . ” does not exclude the existence of other identical elements in the process, method, article, or device.

Provided herein are a method, a device and a medium for multimedia recommendation based on information bottleneck, which solve the problem of inaccurate multimedia recommendation due to feature noise, achieve implicit denoising of pre-training multimedia features, improve the quality of user preference modelling, and improve recommendation performance.

The technical solutions in the embodiments of the disclosure to solve the above technical problems are based on the following ideas.

Deep learning and graph neural networks are two important branches in the field of artificial intelligence. The deep learning has a wide application range such as computer vision and natural language processing. The graph neural networks focus on processing data with a graph structure. The fusion of deep learning and graph neural networks is also gradually being used to solve more complex technical problems.

Recommendation system is an individuation service technology and is commonly used to alleviate information overload brought by massive data. The traditional identity (ID)-based collaborative filtering method portrays user preferences through matrix decomposition or graph neural networks to achieve individuation recommendation of items. With the development of deep learning and multimedia information processing technology, the existing multimedia recommendation methods can use pre-training models for feature extraction of multimedia content and combine with ID information for user preference modelling. After completing the modelling based on user preferences, targeted multimedia information items will be recommended to users.

However, in related technologies, pre-training models are usually task-oriented. For example, visual pre-training models are trained based on visual tasks, the visual feature information extracted by the visual pre-training models is noisy for the recommendation task, and needs to be denoised. The multimedia recommendation methods generally have the problem of feature noise. Since feature noise is difficult to be formally defined, how to implicitly design denoising modules to improve the recommendation task is a critical issue.

The technical solutions of the present disclosure will be further described in detail below in conjunction with the accompanying drawings and embodiments.

A robust multimedia recommendation method based on information bottleneck will be first described.

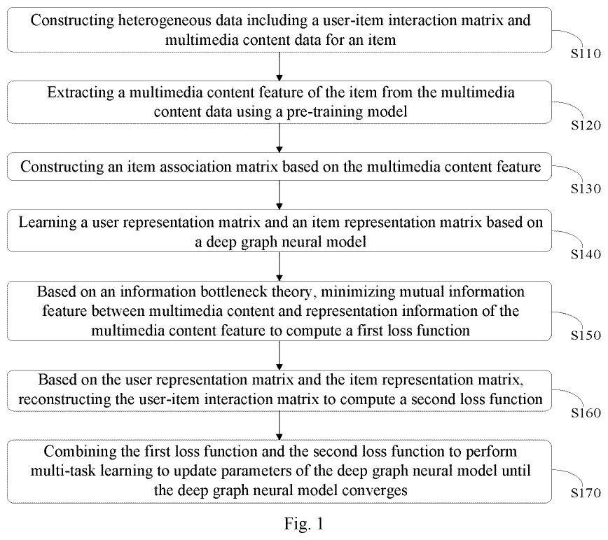

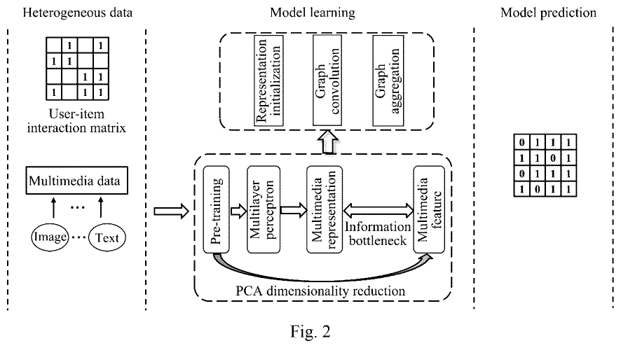

Referring to FIGS. 1 and 2, the robust multimedia recommendation method includes the following steps (110)-(170).
(110) Heterogeneous data including a user-item interaction matrix and multimedia content data for an item is constructed.
(120) A multimedia content feature of the item is extracted from the multimedia content data using a pre-training model.
(130) An item association matrix is constructed based on the multimedia content feature.
(140) A user representation matrix and an item representation matrix are learned based on a deep graph neural model.
(150) Mutual information between the multimedia content feature and representation information of the multimedia content feature is minimized based on an information bottleneck theory to compute a first loss function.
(160) Based on the user representation matrix and the item representation matrix, the user-item interaction matrix is reconstructed to compute a second loss function.
(170) The first loss function and the second loss function are combined to perform multi-task learning to update parameters of the deep graph neural model until the deep graph neural model converges.

It should be noted that deep learning is a neural network-based machine learning method, which simulates the workings of the human brain through a multi level neuronal network to characterize and learn complex data. A graph neural network is the neural network model specifically designed to process graph data, capable of capturing relationships between nodes and global structure. A deep graph neural model is a deep graph neural network. The deep graph neural network is an organic combination of deep learning and graph neural networks, aiming to utilize the powerful representational capabilities of deep learning and the graph structure processing capabilities of graph neural networks, thereby accurately and efficiently modeling and predicting graph data. In deep graph neural networks, each node can be regarded as a sample, and the connectivity between nodes can be represented as the edges of the graph.

It should also be noted that the information bottleneck theory is an extension of the rate-distortion theory of source compression. In traditional data compression, due to the lack of a priori knowledge, it is necessary to remember the input data first, but the redundancy of the data itself can be eliminated. If the data is allowed to be distorted in the compression of the data, based on the rate-distortion theory, there can be a trade off between the distortion and compression bit rate. Based on the information bottleneck theory, if there is corresponding previous knowledge of the data. For example, if the data is labelled, in addition to eliminating the redundancy of the data itself, information unrelated to the labels can be compressed and forgotten, and redundant information unrelated to the learning task can be further eliminated, and compression can be carried out efficiently while retaining the label-related information.

It is to be understood that in this disclosure, after constructing heterogeneous data, and determining the user-item interaction matrix and multimedia content data for the item, the pre-training model is used to extract multimedia content features and perform matrix analysis on the extracted multimedia content features, thereby constructing the item association matrix. The item association matrix may be further processed and engaged in the deep graph neural model to learn the processing of the user-item representation matrix.

It should be emphasized that the user-item representation matrix includes a user representation matrix and an item representation matrix. The deep graph neural model is the deep graph neural network. Based on the information bottleneck theory, the first loss function determined in the present disclosure minimizes the mutual information between the multimedia content and the representation information of the multimedia content, efficiently compresses and extracts the mutual information, and forgets irrelevant redundant information, thereby ensuring the accuracy of data learning. The present disclosure also fuses the user representation matrix and the item representation matrix, reconstructs the user-item interaction matrix, computationally determines the second loss function to combine the first loss function for multi-task learning, and updates the aforementioned deep graph neural model until the deep graph neural model converges. The present disclosure can efficiently remove the feature noise and achieve accurate multimedia recommendation.

Provided above is a specific implementation of the robust multimedia recommendation method based on information bottleneck in combination to embodiments of the present disclosure. The robust multimedia recommendation method learns the user and item representation matrices by means of the deep graph neural model without introducing any model parameters. The method is very lightweight. The information bottleneck constraints are constructed by means of the information bottleneck theory. Mutual information between the multimedia content and its representation information is minimized to obtain the minimum multimedia content satisfying the recommendation task, and then the pre-training multimedia features are denoised, which can implicitly reduce the impact of multimedia noise on user modelling, thus improving the quality of user preference modelling and enhancing the recommendation performance.

In some embodiments, the step (110) specifically includes the following steps (1.1)-(1.2).
(1.1) U represents a user set, U={u₁, . . . uₐ, . . . , u_{b}, . . . u_{M}}. uₐ represents an a-th user; u_{b} represents a b-th user; and M denote the number of users, and 1≤a, b≤M.
V represents an item set, and V={v₁, . . . , vᵢ, . . . , vⱼ, . . . , v_{N}}. vᵢ represents an i-th item. vⱼ represents a j-th item. N represents the number of items, and 1≤i, j≤N.
rₐᵢ represents interaction data between the a-th user uₐ and the i-th item vᵢ, such that the user-item interaction matrix is represented by R={rₐᵢ}_{M×N}.
(1.2) C represents multimedia content of the item set V, and C={C¹, . . . , C^{k}, . . . , C^{K}}. C^{k} represents multimedia content of a k-th modal in the item set V, and C^{k}={c₁^{k}, . . . , cᵢ^{k}, . . . , c_{N}^{k}}. cᵢ^{k} represents multimedia content of a k-th modal of the i-th item vᵢ, and K represents the number of modals, and 1≤k≤K.

In some embodiments, the step (120) specifically includes the following step (2.1).
(2.1) Feature extraction is performed on multimedia content of each of K modals by using a corresponding pre-training model to obtain a multimedia feature matrix set {F¹, . . . , F^{k}, . . . , F^{K}} of the K modals. F^{k} represents a multimedia feature matrix of the k-th modal.

In some embodiments, the step (130) specifically includes the following step (3.1)-(3.4).
(3.1) A similarity matrix set {S¹, . . . , S^{k}, . . . , S^{K}} of the K modals in the item set V is calculated according to formula (1), expressed as:

$${S}^{k} = {L}_{2} ( {F}^{k} ) \times {( {L}_{2} ( {F}^{k} ) )}^{T} . \qquad ( 1 )$$

In the formula (1), S^{k} represents a similarity matrix of the k-th modal in the item set V; L₂(F^{k}) represents a normalized multimedia feature matrix of the k-th modal in the item set V; and T represents matrix transpose.
(3.2) Sparsification is performed on the similarity matrix set {S¹, . . . , S^{k}, . . . , S^{K}} to obtain an association matrix set {S′¹, . . . , S′^{k}, . . . , S′^{K}} of the K modals in the item set V according to formula (2), expressed as:

$${s}_{ij}^{′ k} = \{ \begin{matrix}{s}_{ij}^{k} , {s}_{ij}^{k} ∈ {TopK}^{′} ( {s}_{i}^{k} ) \\ 0 , else\end{matrix} . \qquad ( 2 )$$

In the formula (2), sᵢⱼ^{k} represents an element at a i-th row and a j-th column in the similarity matrix S^{k}; s′ᵢⱼ^{k} represents an element at a i-th row and a j-th column in an association matrix S′^{k} of the k-th modal; sᵢ^{k} represents all elements at the i-th row in the similarity matrix S^{k}; and TopK′ represents first K′ elements in a descending order.
(3.3) An association matrix S′ of the item set V is calculated according to formula (3), expressed as:

$${S}^{′} = {\sum }_{k = 1}^{K} {S}^{′ k} . \qquad ( 3 )$$

(3.4) A representation propagation matrix A is calculated according to formula (4), expressed as:

$$A = [ \begin{matrix}0 & R \\ {R}^{T} & {S}^{′}\end{matrix} ] . \qquad ( 4 )$$

A normalized representation propagation matrix A is calculated according to formula (5), expressed as:

$$\tilde{A} = {D}^{- \frac{1}{2}} {AD}^{- \frac{1}{2}} . \qquad ( 5 )$$

In the formula (5), D represents a degree matrix of the representation propagation matrix A.

In some embodiments, the step (140) specifically includes the following step (4.1)-(4.3).
(4.1) The user representation matrix P={p₁, . . . , pₐ, . . . , p_{M}} is randomly initialized using Gaussian distribution. pₐ represents a (d₁+Kd₂) dimensional representation vector of the a-th user uₐ. d₁ represents a user co-representation dimension; and d₂ represents a content representation dimension.

An item co-representation matrix Q={q₁, . . . , q₂, . . . , q_{N}} is randomly initialized using Gaussian distribution. qᵢ represents a d₁-dimensional representation vector of the i-th item vᵢ.
(4.2) A multimedia content representation matrix T=[T¹, . . . , T^{k}, . . . , T^{K}] of the K modals in the item set V is calculated according to formula (6), expressed as:

$${T}^{k} = {MLP}_{k} ( {F}^{k} ) . \qquad ( 6 )$$

In the formula (6), MLPₖ represents a k-th multilayer perceptron, and T^{k}∈R_{N×d}_{₂} represents a multimedia content representation matrix of the k-th modal in the item set V.
(4.3) The item representation matrix E=[Q, T] is constructed. {P, E} is processed using a graph neural network to obtain a final user representation matrix H^{u} and a final item representation matrix H^{v}.

In some embodiments, the step (150) specifically includes the following step (5.1)-(5.2).
(5.1) Dimensionality reduction is performed on the multimedia feature matrix set {F¹, . . . , F^{k}, . . . , F^{K}} by using a principal component analysis (PCA) algorithm, so as to obtain a dimensionality-reduced multimodal feature matrix {F′¹, . . . , F′^{k} . . . , F′^{K}}. F′^{k}∈R_{N×d}_{₂} represents a dimensionality-reduced matrix of the multimedia feature matrix F^{k}.
(5.2) An information bottleneck loss function is constructed according to formula (10), expressed as:

$$L ( {θ}_{1} ) = {\sum }_{k = 1}^{K} HSIC ( {F}^{′ k} , {T}^{k} ) . \qquad ( 10 )$$

In the formula (10), θ₁ represents a parameter corresponding to K multilayer perceptrons; and HSIC(,) represents a Hilbert-Schmidt independence criterion. It should be noted that the information bottleneck loss function L(θ₁) is the first loss function.

In some embodiments, the step (160) specifically includes the following step (6.1)-(6.2).
(6.1) An interaction probability rₐᵢ′ of the a-th user uₐ with respect to the i—the i-th item vᵢ is predicted according to formula (11), expressed as:

$${r}_{a i}^{′} = δ ( {( {h}_{a}^{u} )}^{T} {h}_{i}^{v} ) . \qquad ( 11 )$$

In the formula (11), δ represents a sigmoid activation function; hₐ^{u} represents a transpose of a representation vector in an a-th row of the final user representation matrix H^{u}; and hᵢ^{v} represents a representation vector in an i-th row of the final item representation matrix H^{v}.
(6.2) A reconstruction loss function L(θ₂) is calculated according to formula (12), expressed as:

$$L ( {θ}_{2} ) = {\sum }_{a = 1}^{M} {\sum }_{( i , j ) ∈ {D}_{a}} ln δ ( {( {h}_{a}^{u} )}^{T} {h}_{j}^{v} - {( {h}_{a}^{u} )}^{T} {h}_{i}^{v} ) . \qquad ( 12 )$$

In the formula (12), θ₂ represents parameters involved in reconstructing the interaction matrix, θ₂=[P, Q, θ₁]; Dₐ represents training data of the a-th user uₐ, and Dₐ={(i, j)|i∈Rₐ, j∈V−Rₐ}; Rₐ represents an interactive item set of the a-th user uₐ; and hⱼ^{v} represents a vector in a j-th row of the final item representation matrix H^{v}. It should be noted that the reconstruction loss function L(θ₂) is the second loss function.

In some embodiments, the step (170) specifically includes the following step (7.1)-(7.3).
(7.1) A multitask optimization objective L(θ) is established according to formula (13), expressed as:

$$L ( θ ) = L ( {θ}_{1} ) + α L ( {θ}_{2} ) + β {‖ [ P , Q , ] ‖}^{2} . \qquad ( 13 )$$

In the formula (13), θ=[P, Q, θ₂] represents all to-be-optimized parameters; and α and β are configured to regulate a weight of the reconstruction loss function and a weight of a regularization term, respectively.
(7.2) The multitask optimization objective L(θ) is solved by using a gradient descent method to update a parameter θ until L(θ) converges to a minimum value, so as to obtain an optimal parameter θ*.
(7.3) An optimal interaction probability rₐᵢ* of the a-th user uₐ with respect to the i-th item vᵢ is predicted according to formula (14), thereby obtaining a predicted interaction matrix R*={rₐᵢ*}_{M×N} of the user set U with respect to the item set V to implement an item recommendation. The formula (14) is expressed as:

$${r}_{a i}^{*} = δ ( {( {h}_{a}^{u *} )}^{T} {h}_{i}^{v *} ) . \qquad ( 14 )$$

In the formula (14), hₐ^{u}* represents an optimal representation vector of the a-th user uₐ; and hᵢ^{v}* represents an optimal representation vector of the i-th item vᵢ.

In an embodiment, in the step (4.3), the graph neural network has L convolutional layers, a current convolutional layer is denoted by l, and is initialized to be 0.

The final user representation matrix H^{u} and the final item representation matrix H^{v} are constructed through the following steps.

A node representation matrix H^{l}={P, E} of a l-th convolutional layer is initialized.

The node representation matrix H^{l}={P, E} is input into the graph neural network, and a node representation matrix H^{l+1} of a (l+1)-th convolutional layer is calculating according to formula (7), expressed as:

$${H}^{l + 1} = \tilde{A} {H}^{l} . \qquad ( 7 )$$

Outputs of individual convolutional layer are aggregated according to formula (8) to obtain a final node representation matrix H:

$$H = \frac{1}{L + 1} {\sum }_{l = 0}^{L} {H}^{l} . \qquad ( 8 )$$

The final user representation matrix H^{u} and the final item representation matrix H^{v} are obtained according to formula (9), expressed as:

$${H}^{u} = H [ : M ] , {H}^{v} = H [ M ∶ ] . \qquad ( 9 )$$

In the formula (9), H[: M] represents 1-st to M-th rows of the final node representation matrix H; and H[M:] represents (M+1)-th to (M+N)-th rows of the final node representation matrix H.

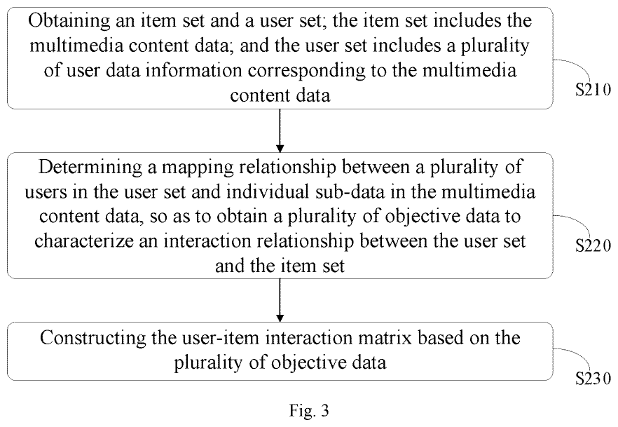

In an embodiment, referring to FIG. 3, the foregoing step of “constructing heterogeneous data”, i.e., the step (110) may specifically include the following steps (210)-(230).
(210) An item set and a user set are obtained. The item set includes the multimedia content data. The user set includes a plurality of user data information corresponding to the multimedia content data.
(220) A first mapping relationship between a plurality of users in the user set and individual sub-data in the multimedia content data is determined, so as to obtain a plurality of first objective data to characterize an interaction relationship between the user set and the item set.
(230) The user-item interaction matrix is constructed based on the plurality of first objective data.

In this embodiment, it is understood that in the process of recommending multimedia items to different users, it is necessary to obtain and analyze a prior item set and a prior user set. The user data information and the multimedia content data correspond to each other. By analyzing the interaction relationship between the user set and the item set, the user-item interaction matrix can be constructed.

In an embodiment, in the process of analyzing the interaction relationship between the user set and the item set, U represents the user set, and U={u₁, . . . uₐ, . . . , u_{b}, . . . u_{M}}. uₐ represents the a-th user; u_{b} represents the b-th user; and M denotes the number of users, and 1≤a, b≤M. rₐᵢ represents the interaction data between the a-th user uₐ and the i-th item vᵢ. R={rₐᵢ}_{M×N} represents the user-item interaction matrix.

In an embodiment, the pre-training model includes a plurality of sub-training models predetermined. The step (120) of “the multimedia content feature of the item is extracted from the multimedia content data using the pre-training model” includes the following steps (310)-(320).
(310) A plurality of specific modals corresponding to the multimedia content data are classified. A second mapping relationship between the plurality of specific modals and the plurality of sub-training models is established.
(320) Based on the second mapping relationship, multimedia content features corresponding to the plurality of specific modals in the item set is extracted respectively through the plurality of sub-training models, thereby obtaining a plurality of multimedia feature matrices and a multimedia feature matrix set.

In an embodiment, it is understood that there is more than a single specific modal in the multimedia content data. In other words, there exists a plurality of categories in the multimedia content data. In order to carry out a target feature extraction of the multimedia content data, a plurality of predetermined sub-training models correspond to a plurality of specific modals. Based on the mapping relationship between a plurality of sub-training models and a plurality of specific modals, multimedia content features of the item set can be extracted by sub-training models. Further, for facilitating data analysis, a plurality of multimedia feature matrices and a set of multimedia feature matrices may be determined based on the results extracted from the item set.

In an embodiment, the multimedia content data corresponds to a plurality of specific modals. The step (130) of “the item association matrix is constructed based on the multimedia content feature” includes the following steps (410)-(430).
(410) A similarity of a plurality of specific modals is analyzed. A plurality of similarity matrices corresponding to a plurality of specific modals and a similarity matrix set are determined.
(420) A plurality of similarity matrices are sparsified and sorted to obtain a target sequence in which a plurality of elements are sequentially arranged in a descending order.
(430) A predetermined number of larger elements (first n elements) are selected from the target sequence to determine the item association matrix among a plurality of items and an association matrix set, and n is a predetermined value.

In an embodiment, it is understood that different multimedia items are not completely opposite in content. In the process of classifying multimedia content data based on specific modals, the items under different specific modals are not completely different. In other words, there exists a certain similarity degree between a plurality of specific modals, and there is a difference in the similarity degree between two different specific modals. Thus, in considering different specific modals for data analysis to achieve the multimedia content recommendation, the accuracy of recommendation can be further ensured by analyzing and studying the similarity between multiple specific modals.

It is to be noted that after obtaining a plurality of similarity matrices, a set of significant target sequences can be obtained by sparsification and sorting, and by selecting a predetermined number of larger elements from the target sequences, a set of significant association matrices can be determined for subsequent analysis.

In an embodiment, after performing the step (130) of “the item association matrix is constructed based on the multimedia content feature”, the robust multimedia recommendation method further includes steps (131)-(133).
(131) The user-item interaction matrix is determined as a first matrix subset, and the first matrix subset is transposed to obtain a second matrix subset.
(132) The item association matrix is determined as a third matrix subset.
(133) A first representation propagation matrix is constructed based on the first matrix subset, the second matrix subset, and the third matrix subset.

In an embodiment, it is to be understood that based on the aforementioned step (230) of determining the user-item interaction matrix and the aforementioned step (430) of determining the significant item association matrix, in order to initially establish a relationship between the aforementioned analytical results and the deep graph neural model, the prior user set and the prior item set are combined with the graph neural network in the deep graph neural model. The matrix aggregation may be performed based on the user-item interaction matrix and the item association matrix to fuse association relationships between users and items, and association relationships between multiple items. Specifically, a first representation propagation matrix may be constructed based on the user-item interaction matrix and the item association matrix. It is also noted that the item association matrix is consistent with the association matrix in the step (3.3).

In an embodiment, the first representation propagation matrix A may be represented as:

$$A = [ \begin{matrix}0 & R \\ {R}^{T} & {S}^{′}\end{matrix} ] .$$

In the above formula, R is the user-item interaction matrix, R^{T} is the transpose matrix corresponding to the user-item interaction matrix, and S′ is the item association matrix.

In an embodiment, after the step (133) of “the first representation propagation matrix is constructed based on the first matrix subset, the second matrix subset, and the third matrix subset”, the robust multimedia recommendation method further includes steps (134)-(135).
(134) A degree matrix of the first representation propagation matrix is calculated.
(135) The first representation propagation matrix is normalized by multiplying the first representation propagation matrix by the degree matrix to obtain a second representation propagation matrix.

In an embodiment, it is to be understood that after determining the first representation propagation matrix, in order to more accurately combine with the graph neural network in the depth graph neural model, the degree matrix of the first representation propagation matrix may be analyzed, and then the first representation propagation matrix may be normalized based on the degree matrix to obtain the second representation propagation matrix. The second representation propagation matrix can participate in the iterative computation of the graph neural network, so that the deep graph neural model is more closely aligned with the prior data such as the user set and the item set.

In an embodiment, the first representation propagation matrix is consistent with the representation propagation matrix A in the step (3.4), and the second representation propagation matrix is consistent with the representation propagation matrix Ã in the aforementioned step (3.4).

In an embodiment, the user-item representation matrix includes the user representation matrix and the item representation matrix. The step (140) of “the user representation matrix and the item representation matrix are learned based on the deep graph neural model” includes the steps (510)-(560).
(510) An initialized user representation matrix and an initialized item co-representation matrix are randomly generated via Gaussian distribution.
(520) A multimedia content representation matrix of the item is computed by using a predetermined multilayer perceptron.
(530) The initialized item co-representation matrix is fused with the multimedia content representation matrix to determine the item representation matrix.
(540) The initialized user representation matrix is fused with the item representation matrix to determine a 0^{th}-layer node representation matrix.
(550) The 0^{th}-layer node representation matrix is input into a predetermined graph neural network, and the second representation propagation matrix is taken as an iterative coefficient to obtain a plurality of intermediate node representation matrices respectively corresponding to a plurality of convolutional layers in the predetermined graph neural network.
(560) Based on the number of a plurality of convolutional layers in the predetermined graph neural network, a plurality of intermediate node representation matrices and the 0^{th}-layer node representation matrix are aggregated to obtain the final node representation matrix.

In an embodiment, it is understood that the deep graph neural model consists of a plurality of convolutional layers, pooling layers, and fully-connected layers. In the process of analyzing the representational properties of the user and the item based on the deep graph neural model, the 0^{th}-layer convolutional layer may be initialized based on Gaussian distribution. Specifically, the initialized user representation matrix and the initialized item co-representation matrix may be randomly generated by Gaussian distribution. Further, the multimedia content representation matrix of the item is computed by the multilayer perceptron. A fusion analysis is performed on the initialized user representation matrix, the initialized item co-representation matrix, and the multimedia content representation matrix to determine the 0^{th}-layer node representation matrix.

In addition, based on the second representation propagation matrix and the layer node representation matrix, the graph neural network is adjusted to obtain the intermediate node representation matrix corresponding to a plurality of convolutional layers. Further, based on the number of convolutional layers, a plurality of intermediate node representation matrices and the 0^{th}-layer node representation matrix are aggregated to obtain the final node representation matrix.

In an embodiment, the final node representation matrix H is expressed as:

$$H = \frac{1}{L + 1} {\sum }_{l = 0}^{L} {H}^{l} . \qquad ( 15 )$$

In the above formula, L is the number of a plurality of convolutional layers; l represents the current convolutional layer; and H^{l} represents the node representation matrix of the l-th convolutional layer.

In another embodiment, the initialized user representation matrix may be expressed as P={p₁, . . . , pₐ, . . . , p_{M}}, and pₐ represents the (d₁+Kd₂)-dimensional representation vector of the a-th user uₐ. d₁ represents the user co-representation dimension; and d₂ represents the content representation dimension. The initialized item co-representation matrix may be expressed as Q={q₁, . . . , qᵢ, . . . , q_{N}}. qᵢ represents a d₁-dimensional representation vector of the i-th item vᵢ. The multimedia content representation matrix may be expressed as T=[T¹, . . . , T^{k}, . . . , T^{K}], and T^{k}=MLPₖ(F^{k}). MLPₖ represents the k-th multilayer perceptron, and T^{k}∈R_{N×d}_{₂} represents the multimedia content representation matrix of the k-th modal in the item set V.

Specifically, the item representation matrix is expressed as E=[Q, T], and the 0^{th}-layer node representation matrix is expressed as {P, E}, based on which the final node representation matrix is obtained by aggregating a plurality of intermediate node representation matrices and the 0^{th}-layer node representation matrix, thereby covering both user information and item information.

In an embodiment, after the step (560) of “based on the number of a plurality of convolutional layers in the graph neural network, a plurality of intermediate node representation matrices and the 0-layer node representation matrix are aggregated to obtain the final node representation matrix”, the robust multimedia recommendation method further includes step (570).
(570) Individual row vectors in the final node representation matrix are analyzed and extracted to determine the final user representation matrix H^{u} and the final item representation matrix H^{v}.

In an embodiment, it is understood that since the final node representation matrix is obtained by aggregating a plurality of matrices and covers user information and item information; different subsets of the final node representation matrix can characterize correspondingly different information; and the individual row vectors in the final node representation matrix are extracted to obtain the final user representation matrix and the final item representation matrix.

In an embodiment, the final user representation matrix H^{u} is expressed as: H^{u}=H[: M]. H[: M] represents 1-st to M-th rows of the final node representation matrix H.

The final item representation matrix H^{v} is expressed as: H^{v}=H[M:]. H[M:] represents (M+1)-th to (M+N)-th rows of the final node representation matrix H.

In an embodiment, the representation information of the multimedia content is the multimedia content representation matrix, and the first loss function is the information bottleneck loss function. The step (150) of “based on the information bottleneck theory, mutual information between the multimedia content and the representation information of the multimedia content is minimized to compute the first loss function” includes the following steps (610)-(620).
(610) Dimensionality reduction is performed on the multimedia feature matrix set using the PCA algorithm to obtain the dimensionality-reduced multimodal feature matrix.
(620) Based on the information bottleneck theory, a Hilbert-Schmidt independence criterion between the dimensionality-reduced multimodal feature matrix and the multimedia content representation matrix is calculated to obtain the information bottleneck loss function.

It is understood that the PCA algorithm is a principal component analysis method. The PCA transforms the original data into a set of linearly independent representations in various dimensions by linear transformation, which can be used to extract the main feature components of the data. The high-dimensional multimedia feature matrix set is performed with the dimensionality reduction by the PCA algorithm to obtain the dimensionality-reduced multimodal feature matrix. Based on the information bottleneck theory, the Hilbert-Schmidt independence criterion is constructed to obtain the information bottleneck loss function, which can provide constraints for data analysis, and obliviously eliminate redundant information irrelevant to the learning task, thus ensuring the accuracy of data learning.

In an embodiment, the information bottleneck loss function is expressed as:

$$L ( {θ}_{1} ) = {\sum }_{k = 1}^{K} HSIC ( {F}^{′ k} , {T}^{k} ) . \qquad ( 16 )$$

In the formula (16), L(θ₁) represents the information bottleneck loss function; θ₁ represents parameters corresponding to K multilayer perceptrons; HSIC(,) represents the Hilbert-Schmidt independence criterion; F′^{K} represents the dimensionality-reduced multimodal feature matrix; and T^{k} represents the multimedia content representation matrix.

In an embodiment, the second loss function is the reconstruction loss function. The step (160) of “the interaction matrix is reconstructed based on the user representation matrix and the item representation matrix to compute a second loss function” includes the following steps (710)-(720).
(710) The final user representation matrix and the final item representation matrix are processed by using a predetermined sigmoid activation function. The interaction probability of each user for the item is predicted to reconstruct the user-item interaction matrix.
(720) The reconstruction loss function is calculated based on a plurality of predicted interaction probabilities and all parameters involved in reconstructing the user-item interaction matrix.

In an embodiment, after generating the final user representation matrix H^{u} and the final item representation matrix H^{v} based on the aforementioned deep graph neural model, it can be understood that due to the large range of data in the final user representation matrix H^{u} and the final item representation matrix H^{v}, in order to facilitate data analysis and statistics, the data in the final user representation matrix H^{u} and the final item representation matrix H^{v} can be mapped to [0, 1] by means of the sigmoid activation function. Based on the mapped data in the final user representation matrix H^{u} and the final item representation matrix H^{v}, the interaction probability between the user and the item can be predicted, thereby reconstructing and generating the user-item interaction matrix based on the prediction by the deep graph neural model, and calculating and determining the reconstruction loss function.

In an embodiment, the heterogeneous data further includes the item set. The plurality of predicted interaction probabilities between the user and the item are expressed as:

$${r}_{a i}^{′} = δ ( {( {h}_{a}^{u} )}^{T} {h}_{i}^{v} ) . \qquad ( 17 )$$

In the formula (17), rₐᵢ′ represents the predicted interaction probabilities; δ represents the sigmoid activation function; hₐ^{u} represents a transpose of a representation vector in the a-th row of the final user representation matrix H^{u}; and hᵢ^{v} represents a representation vector in the i-th row of the final item representation matrix H^{v}.

The reconstruction loss function L(θ₂) is expressed as:

$$L ( {θ}_{2} ) = {\sum }_{a = 1}^{M} {\sum }_{( i , j ) ∈ {D}_{a}} ln δ ( {( {h}_{a}^{u} )}^{T} {h}_{j}^{v} - {( {h}_{a}^{u} )}^{T} {h}_{i}^{v} ) . \qquad ( 18 )$$

In the formula (18), θ₂ represents the parameters involved in reconstructing the user-item interaction matrix and corresponds to the reconstruction loss function, and θ₂=[P, Q, θ₁]; P is the initialized user representation matrix; Q is the initialized item co-representation matrix; and θ₁ represents parameters corresponding to K multilayer perceptrons.

Dₐ represents training data of the a-th user uₐ, and Dₐ={(i, j)|i∈Rₐ, j∈V−Rₐ}; Rₐ represents the interactive item set of the a-th user uₐ; V represents the item set; and hⱼ^{v} represents the vector in the j-th row of the final item representation matrix H^{v}.

In an embodiment, the first loss function is the information bottleneck loss function, and the second loss function is the reconstruction loss function. The step (170) of “the first loss function and the second loss function are combined to perform multi task learning to update parameters of the deep graph neural model until the deep graph neural model converges” includes the following steps (810)-(840).
(810) A multitask optimization objective function is established based on the information bottleneck loss function and the reconstruction loss function. The multitask optimization objective function corresponds to all to-be-optimized parameters.
(820) The multitask optimization objective function is solved by a gradient descent method to update all the to-be-optimized parameters.
(830) A corresponding parameter when the multitask optimization objective function converges to a minimum value is determined as an optimal parameter after updating all the to-be-optimized parameters.
(840) Based on the optimal parameter, a target interaction probability of each user for the item is separately predicted to determine a target interaction matrix, so as to achieve the item recommendation.

It is understood that the gradient descent method is an iterative algorithm. After obtaining the information bottleneck loss function and the reconstruction loss function, the corresponding multitask optimization objective function can be constructed based on all the to-be-optimized parameters. Further, the multitask optimization objective function can be solved by the gradient descent method until the multitask optimization objective function converges, thereby determining the optimal parameters to obtain the target interaction matrix to recommend items to users.

In an embodiment, the multitask optimization objective function is expressed as:

$$L ( θ ) = L ( {θ}_{1} ) + α L ( {θ}_{2} ) + β {‖ [ P , Q , ] ‖}^{2} . \qquad ( 19 )$$

In the formula (19), θ=[P, Q, θ₂] represents all the to-be-optimized parameters; P is the initialized user representation matrix; Q is the initialized item co-representation matrix; θ₂ represents all the parameters corresponding to the reconstruction loss function; ∥[P, Q]∥² is the regularization term; and α and β are configured to regulate the weight of the reconstruction loss function and the weight of the regularization term, respectively.

The target interaction matrix is expressed as: R*={rₐᵢ*}_{M×N} rₐᵢ*=δ((hₐ^{u}*)^{T} hᵢ^{v}*); hₐ^{u}* represents the target representation vector of the a-th user uₐ; and hᵢ^{v}* represents the target representation vector of the i-th item vᵢ.

In an embodiment, in order to verify the effectiveness of the robust multimedia recommendation method in this disclosure, three commonly-used Amazon datasets are used for comparison experiments, namely, Clothing, Sports, and Baby. For each user, 1 item that the user interacts with is randomly selected as the test set, and the rest of the interaction data is used as the training set. For each user-item interaction record, 1 item that the user has not interacted with is randomly sampled to form a triple for model training. In the testing phase, all the items that the user has not interacted with are ranked where the recall rate (Recall@N) and the normalized discounted cumulative gain (NDCG@ N) are used as evaluation criteria.

Five related methods, namely BPR-MF, LightGCN, VBPR, LightGCN-M, and LATTICE, are selected for effect comparison. Specifically, Tables 1-3 show the experimental results on the above three datasets, respectively.

TABLE 1
Comparison of recommendation results between the
robust multimedia recommendation in this disclosure
and comparison methods on Clothing dataset

| Models | Recall@10 | NDCG@10 | Recall@20 | NDCG@20 |
|---|---|---|---|---|
| BPR-MF | 0.0189 | 0.0102 | 0.0267 | 0.0122 |
| LightGCN | 0.0357 | 0.0198 | 0.0542 | 0.0246 |
| VBPR | 0.0342 | 0.0186 | 0.0515 | 0.0230 |
| LightGCN + M | 0.0416 | 0.0228 | 0.0625 | 0.0281 |
| LATTICE | 0.0448 | 0.0248 | 0.0677 | 0.0306 |
| IBRec (this | 0.0467 | 0.0253 | 0.0708 | 0.0314 |
| disclosure) | | | | |

TABLE 2
Comparison of recommendation results between the
robust multimedia recommendation in this disclosure
and comparison methods on Sports dataset

| Models | Recall@10 | NDCG@10 | Recall@20 | NDCG@20 |
|---|---|---|---|---|
| BPR-MF | 0.0444 | 0.0247 | 0.0661 | 0.0304 |
| LightGCN | 0.0572 | 0.0324 | 0.0853 | 0.0398 |
| VBPR | 0.0487 | 0.0271 | 0.0731 | 0.0335 |
| LightGCN + M | 0.0635 | 0.0360 | 0.0952 | 0.0443 |
| LATTICE | 0.0650 | 0.0366 | 0.0969 | 0.0450 |
| IBRec(this | 0.0667 | 0.0379 | 0.1000 | 0.0465 |
| disclosure) | | | | |

TABLE 3
Comparison of recommendation results between the
robust multimedia recommendation in this disclosure
and comparison methods on Baby dataset

| Models | Recall@10 | NDCG@10 | Recall@20 | NDCG@20 |
|---|---|---|---|---|
| BPR-MF | 0.0376 | 0.0202 | 0.0612 | 0.0264 |
| LightGCN | 0.0493 | 0.0268 | 0.0773 | 0.0342 |
| VBPR | 0.0446 | 0.0248 | 0.0688 | 0.0311 |
| LightGCN + M | 0.0554 | 0.0303 | 0.0868 | 0.0385 |
| LATTICE | 0.0583 | 0.0320 | 0.0891 | 0.0400 |
| IBRec (this | 0.0590 | 0.0322 | 0.0914 | 0.0408 |
| disclosure) | | | | |

As shown in the above tables 1-3, on all three datasets of Clothing, Sports, and Baby, the IBRec method provided in the present disclosure significantly outperforms the five comparison methods in all four criterions of Recall@10, NDCG@10, Recall@20 and NDCG@20.

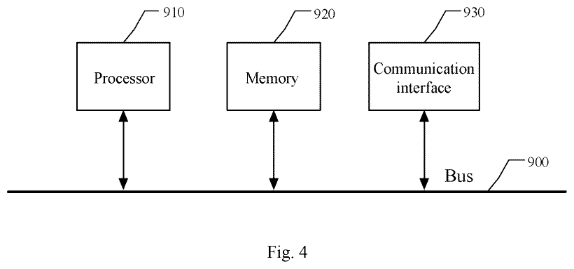

Referring to FIG. 4, the present disclosure also provides an electronic device.

The electronic device includes a processor 910 and a memory 920 storing computer program instructions.

Specifically, the processor 910 may include a central processing unit (CPU), or an Application Specific Integrated Circuit (ASIC), or may be configured to have one or more integrated circuits implement of embodiments of the present disclosure.

The memory 920 may include mass storage device for data or instructions. For example, the memory 920 may include a hard disk drive (HDD), a floppy disk drive, a flash memory, an optical disc, a magneto-optical disc, a magnetic tape, or a Universal Serial Bus (USB) drive or a combination thereof, but not limited to this. In an embodiment, the memory 920 may include removable or non-removable (or fixed) media. In an embodiment, the memory 920 may be inside or outside the integrated gateway redundancy device. In an embodiment, the memory 920 is non-volatile solid-state memory.

The memory 920 may include read-only memory (ROM), random access memory (RAM), a disk storage media device, an optical storage media device, a flash memory device, an electrical, optical, or other physical/tangible memory storage device. Thus, typically, the memory 920 includes one or more tangible (non-transitory) computer-readable storage media (e.g., memory devices) encoded with software including computer-executable instructions. When the software is executed (e.g., by one or more processors), the processor implements the operations in the information bottleneck-based robust multimedia recommendation method in the embodiments described above.

The processor 910 implements any one of the information bottleneck-based robust multimedia recommendation methods in the above-described embodiments by reading and executing the computer program instructions stored in the memory 920.

In an embodiment, the electronic device may further include a communication interface 930 and a bus 900. As shown in FIG. 4, the processor 910, the memory 920, and the communication interface 930 are connected and complete communication with each other via the bus 900.

The communication interface 930 is mainly used to implement the communication between the modules, devices, units, and/or equipment in the present disclosure.

The bus 900 includes hardware or/and software that couples the components of the online data traffic accounting device to each other. For example, the bus may include an accelerated graphics port (AGP) or other graphics bus, an enhanced industry standard architecture (EISA) bus, a front side bus (FSB), a hyper-transport (HT) interconnect, an industry standard architecture (ISA) bus, an Infinite Bandwidth Interconnect, a low pin count (LPC) bus, a memory bus, a micro channel architecture (MCA) bus, a peripheral component interconnect (PCI) bus, pci-express (PCI-X) bus, serial advanced technology attachment (SATA) bus, video electronics standards association local (VLB) bus, or a combination thereof, but not limited to it. Where appropriate, the bus 900 may include one or more buses. Although specific buses are described and illustrated in the present disclosure, the present disclosure contemplates any suitable bus or interconnect.

The present disclosure further provides a computer storage medium to implement the information bottleneck-based robust multimedia recommendation method of the above embodiments. The computer storage medium is stored with computer program instructions. The computer program instructions are executed by the processor to implement any one of the information bottleneck-based robust multimedia recommendation methods of the above embodiments.

It should be noted that the present disclosure is not limited to the particular configurations and processing described above and illustrated in the figures. Detailed descriptions of known methods are omitted herein for the sake of brevity. In the above embodiments, the number of specific steps are described and illustrated as examples. However, the method of the present disclosure is not limited to the specific steps described, and those skilled in the art may make various changes, modifications, and additions, or change the order between the steps without departing from the spirit of the disclosure.

The functional blocks shown in the above block diagram of the structure may be implemented as hardware, software, firmware, or a combination thereof. When implemented as hardware, it may be an electronic circuit, an application-specific integrated circuit (ASIC), appropriate firmware, a plug-in, or a function card. When implemented in software, an element of the present disclosure is a program or code segment that is used to perform a desired task. The program or code segment may be stored in a machine-readable medium or transmitted over a transmission medium or communication link by a data signal carried in a carrier. “Machine-readable medium” may include any medium capable of storing or transmitting information. For example, the machine-readable media include an electronic circuit, a semiconductor memory device, a read-only memory (ROM), a flash memory, an erasable read-only memory (EROMs), a floppy disk, a CD-ROM, an optical disk, a hard disk, an optical fiber media, or a radio frequency (RF) link. The code segments may be downloaded via a computer network such as the Internet or an Intranet.

It is also noted that the present disclosure is not limited to the order of the above steps. For example, the steps may be performed in the order mentioned in the embodiments or in a different order from the embodiments, or several steps may be performed simultaneously.

The present disclosure i described above with reference to flowcharts and/or block diagrams of methods, devices (systems) and computer program items according to embodiments of the present disclosure. It should be understood that each box in the flowcharts and/or block diagrams and combinations of boxes in the flowcharts and/or block diagrams may be implemented by computer program instructions. These computer program instructions may be provided to a processor of a general-purpose computer, a special-purpose computer, or other programmable data-processing devices to produce a machine such that these instructions, executed via the processor of the computers or other programmable data-processing devices, can implement the function/action in one or more of the boxes of the flowchart and/or the block diagram. The processor may be, but is not limited to, a general-purpose processor, a special-purpose processor, a special application processor, or a field programmable logic circuit. It is also understood that each of the boxes in the block diagram and/or flowchart and combinations of the boxes in the block diagram and/or flowchart may also be implemented by special hardware that performs the special function or action, or may be implemented by a combination of special hardware and computer instructions.

Compared to the prior art, this application has the following beneficial effects.
1. The present disclosure, by means of information bottleneck constraints, can efficiently compress data information in addition to eliminating redundancy of the data itself, forget other redundant information unrelated to the recommendation task, learn the minimum multimedia content to satisfy the recommendation task, and denoise the pre-training multimedia features, thereby realizing a more accurate multimedia recommendation.
2. This disclosure analyzes the data in the user set and the item set in real time, and determines the user representation matrix and the item representation matrix, in order to reconstruct the interaction matrix and compute the reconstruction loss function. Then, the information bottleneck loss function and the reconstruction loss function are jointly used for multi-task learning in real time. Further, the multitask optimization objective function is established, so as to achieve the accuracy and real-time of the recommendation of multimedia items based on the deep graph neural model.
3. The multimedia denoising method based on information bottleneck proposed in this application is very lightweight without introducing any model parameters, and has strong practical value.
4. This disclosure uses the Hilbert-Schmidt independence constraint to construct the information bottleneck module, which is used to minimize the mutual information between the multimedia content and its representation information, which can implicitly reduce the influence of the multimedia noise on the user modeling, improve the quality of the user preference modeling, and improve the recommendation performance of the multimedia items.
5. The information bottleneck-based multimedia denoising method proposed in this disclosure has high generality, and can be embedded in any recommendation method based on representation learning, as well as being applicable to numerous recommendation scenarios.

Described above are merely preferred embodiments to illustrate the technical solutions of the disclosure, which are not intended to limit the disclosure. It should be understood that any modifications and replacements made by those skilled in the art without departing from the spirit of the disclosure should fall within the scope of the disclosure defined by the appended claims.

What is claimed is:

1. A robust multimedia recommendation method based on information bottleneck, comprising:
(S1) constructing heterogeneous data comprising a user-item interaction matrix and multimedia content data of an item;
(S2) extracting a multimedia content feature of the item from the multimedia content data using a pre-training model;
(S3) constructing an item association matrix based on the multimedia content feature;
(S4) learning a user representation matrix and an item representation matrix based on a deep graph neural model;
(S5) minimizing, based on an information bottleneck theory, mutual information between the multimedia content feature and representation information of the multimedia content feature to compute a first loss function;
(S6) reconstructing the user-item interaction matrix based on the user representation matrix and the item representation matrix to compute a second loss function; and
(S7) combining the first loss function and the second loss function to perform multi-task learning to update parameters of the deep graph neural model until the deep graph neural model converges.

2. The robust multimedia recommendation method of claim 1, wherein step (S1) comprises:
(1.1) denoting a user set by U, wherein U={u₁, . . . uₐ, . . . , u_{b}, . . . u_{M}}; uₐ represents an a-th user; u_{b} represents a b-th user; and M represents the number of users, and 1≤a, b≤M;
denoting an item set by V, wherein V={v₁, . . . , vᵢ, . . . , vⱼ, . . . , v_{N}}; vᵢ represents an i-th item; vⱼ represents a j-th item; and N represents the number of items, and 1≤i, j≤N;
denoting interaction data between the a-th user uₐ and the i-th item vᵢ by rₐᵢ such that the user-item interaction matrix is represented by R={rₐᵢ}_{M×N}; and
(1.2) denoting multimedia content of the item set V by C, wherein C={C¹, . . . , C^{k}, . . . , C^{K}}; C^{k} represents multimedia content of a k-th modal in the item set V, C^{k}={c₁^{k}, . . . , cᵢ^{k}, . . . , c_{N}^{k}}; cᵢ^{k} represents multimedia content of a k-th modal of the i-th item vᵢ, and K represents the number of modals, and 1≤k≤K;
step (S2) comprises:
(2.1) performing feature extraction on multimedia content of each of K modals by using a corresponding pre-training model to obtain a multimedia feature matrix set {F¹, . . . , F^{k}, . . . , F^{K}} of the K modals, wherein F^{k} represents a multimedia feature matrix of the k-th modal;
step (S3) comprises:
(3.1) calculating a similarity matrix set {S¹, . . . , S^{k}, . . . , S^{K}} of the K modals in the item set V according to formula (1), expressed as:
$${S}^{k} = {L}_{2} ( {F}^{k} ) \times {( {L}_{2} ( {F}^{k} ) )}^{T} ; \qquad ( 1 )$$
wherein S^{k} represents a similarity matrix of the k-th modal in the item set V; L₂(F^{k}) represents a normalized multimedia feature matrix of the k-th modal in the item set V; and T represents matrix transpose;
(3.2) performing sparsification on the similarity matrix set {S¹, . . . , S^{k}, . . . , S^{K}} to obtain an association matrix set {S′¹, . . . , S′^{k}, . . . , S′^{K}} of the K modals in the item set V according to formula (2), expressed as:
$${s}_{i j}^{′ k} = \{ \begin{matrix}{s}_{ij}^{k} , {s}_{i j}^{k} ∈ T o p K ′ ( {s}_{i}^{k} ) \\ 0 , else\end{matrix} ; \qquad ( 2 )$$
wherein sᵢⱼ^{k} represents an element at a i-th row and a j-th column in the similarity matrix S^{k}; s′ᵢⱼ^{k} represents an element at a i-th row and a j-th column in an association matrix S′^{k} of the k-th modal; sᵢ^{k} represents all elements at the i-th row in the similarity matrix S^{k}; and TopK′ represents first K′ elements in a descending order;
(3.3) calculating an association matrix S′ of the item set V according to formula (3), expressed as:
$${S}^{′} = {\sum }_{k = I}^{K} {S}^{′k} ; \qquad ( 3 )$$
and
(3.4) calculating a representation propagation matrix A according to formula (4), expressed as:
$$A = [ \begin{matrix}0 & R \\ {R}^{T} & {S}^{′}\end{matrix} ] ; \qquad ( 4 )$$
and
calculating a normalized representation propagation matrix Ã according to formula (5), expressed as:
$$\tilde{A} = {D}^{- \frac{1}{2}} {AD}^{- \frac{1}{2}} ; \qquad ( 5 )$$
wherein D represents a degree matrix of the representation propagation matrix A;
step (S4) comprises:
(4.1) randomly initializing the user representation matrix P={p₁, . . . , pₐ, . . . , p_{M}} using Gaussian distribution, wherein pₐ represents a (d₁+Kd₂)-dimensional representation vector of the a-th user uₐ; d₁ represents a user co-representation dimension; and d₂ represents a content representation dimension; and
randomly initializing an item co-representation matrix Q={q₁, . . . , qᵢ, . . . , q_{N}} using Gaussian distribution, wherein qᵢ represents a d₁-dimensional representation vector of the i-th item vᵢ;
(4.2) calculating a multimedia content representation matrix T=[T¹, . . . , T^{k}, . . . , T^{K}] of the K modals in the item set V according to formula (6), expressed as:
$${T}^{k} = {MLP}_{k} ( {F}^{k} ) ; \qquad ( 6 )$$
wherein MLPₖ represents a k-th multilayer perceptron; and T^{k}∈R_{N×d}_{₂} represents a multimedia content representation matrix of the k-th modal in the item set V; and
(4.3) constructing the item representation matrix E=[Q, T]; and processing {P, E} through a graph neural network to obtain a final user representation matrix H^{u} and a final item representation matrix H^{v};
step (S5) comprises:
(5.1) performing dimensionality reduction on the multimedia feature matrix set {F¹, . . . , F^{k}, . . . , F^{K}} by using a principal component analysis (PCA) algorithm, so as to obtain a dimensionality-reduced multimodal feature matrix {F′¹, . . . , F′^{k}, . . . , F′^{K}}; wherein F′^{k}∈R_{N×d}_{₂} represents a dimensionality-reduced matrix of the multimedia feature matrix F^{k}; and
(5.2) constructing an information bottleneck loss function according to formula (7), expressed as:
$$L ( {θ}_{1} ) = {\sum }_{k = 1}^{K} HSIC ( {F}^{′ k} , {T}^{k} ) ; \qquad ( 7 )$$
wherein θ₁ represents a parameter corresponding to K multilayer perceptrons; and HSIC(,) represents a Hilbert-Schmidt independence criterion;
step (S6) comprises:
(6.1) predicting an interaction probability rₐᵢ′ of the a-th user uₐ with respect to the i-th item vᵢ according to formula (8), expressed as:
$${r}_{a i}^{′} = δ ( {( {h}_{a}^{u} )}^{T} {h}_{i}^{v} ) ; \qquad ( 8 )$$
wherein δ represents a sigmoid activation function; hₐ^{u} represents a transpose of a representation vector in an a-th row of the final user representation matrix H^{u}; and hᵢ^{v} represents a representation vector in an i-th row of the final item representation matrix H^{v}; and
(6.2) calculating a reconstruction loss function L(θ₂) according to formula (9), expressed as:
$$L ( {θ}_{2} ) = {\sum }_{a = 1}^{M} {\sum }_{( i , j ) ∈ {D}_{a}} ln δ ( {( {h}_{a}^{u} )}^{T} {h}_{j}^{v} - {( {h}_{a}^{u} )}^{T} {h}_{i}^{v} ) ; \qquad ( 9 )$$
wherein θ₂ represents parameters involved in reconstructing the interaction matrix, θ₂=[P, Q, θ₁]; Dₐ represents training data of the a-th user uₐ, and Dₐ={(i, j)|i∈Rₐ, j∈V−Rₐ}; Rₐ represents an interactive item set of the a-th user uₐ; and hⱼ^{v} represents a vector in a j-th row of the final item representation matrix H^{v};
step (S7) comprises:
(7.1) establishing a multitask optimization objective L(θ) according to formula (10), expressed as:
$$L ( θ ) = L ( {θ}_{1} ) + α L ( {θ}_{2} ) + β {‖ [ P , Q , ] ‖}^{2} ; \qquad ( 10 )$$
wherein θ=[P, Q, θ₂] represents to-be-optimized parameters; and α and β are configured to regulate a weight of the reconstruction loss function and a weight of a regularization term, respectively;
(7.2) solving the multitask optimization objective L(θ) by using a gradient descent method to update a parameter θ until L(θ) converges to a minimum value, so as to obtain an optimal parameter θ*; and
(7.3) predicting an optimal interaction probability rₐᵢ* of the a-th user uₐ with respect to the i-th item vᵢ according to formula (11), thereby obtaining a predicted interaction matrix R*={rₐᵢ*}_{M×N} of the user set U with respect to the item set V to achieve item recommendation, wherein the formula (11) is expressed as:
$${r}_{a i}^{*} = δ ( {( {h}_{a}^{u *} )}^{T} {h}_{i}^{v *} ) ; \qquad ( 11 )$$
wherein hₐ^{u}* represents an optimal representation vector of the a-th user uₐ; and hᵢ^{v}* represents an optimal representation vector of the i-th item vᵢ.

3. The robust multimedia recommendation method of claim 2, wherein in step (4.3), the graph neural network has L convolutional layers, and a current convolutional layer is denoted by l, and is initialized to be 0; and
the final user representation matrix H^{u} and the final item representation matrix H^{v} are constructed through the following steps:
initializing a node representation matrix H^{l}={P, E} of a l-th convolutional layer;
inputting the node representation matrix H^{l}={P, E} into the graph neural network; and calculating a node representation matrix H^{l+1} of a (l+1)-th convolutional layer according to formula (12), expressed as:
$${H}^{l + 1} = \tilde{A} {H}^{l} ; \qquad ( 12 )$$
aggregating outputs of individual convolutional layers according to formula (13) to obtain a final node representation matrix H:
$$H = \frac{1}{L + 1} {\sum }_{l = 0}^{L} {H}^{l} ; \qquad ( 13 )$$
obtaining the final user representation matrix H^{u} and the final item representation matrix H^{v} according to formula (14), expressed as:
$${H}^{u} = H [ : M ] , {H}^{v} = H [ M : ] ; \qquad ( 14 )$$
wherein H[: M] represents 1-st to M-th rows of the final node representation matrix H; and H[M:] represents (M+1)-th to (M+N)-th rows of the final node representation matrix H.

4. The robust multimedia recommendation method of claim 1, wherein the step of constructing the heterogeneous data comprises:
obtaining an item set and a user set, wherein the item set comprises the multimedia content data, and the user set comprises a plurality of user data information corresponding to the multimedia content data;
determining a mapping relationship between a plurality of users in the user set and individual sub-data in the multimedia content data, so as to obtain a plurality of objective data to characterize an interaction relationship between the user set and the item set; and
constructing the user-item interaction matrix based on the plurality of objective data.

5. The robust multimedia recommendation method of claim 1, wherein the pre-training model comprises a plurality of sub-training models predetermined; and
the step of extracting the multimedia content feature of the item using the pre-training model comprises:
classifying a plurality of specific modals corresponding to the multimedia content data; and establishing a mapping relationship between the plurality of specific modals and the plurality of sub-training models; and
extracting, based on the mapping relationship, multimedia content features respectively corresponding to the plurality of specific modals in an item set through the plurality of sub-training models, thereby obtaining a plurality of multimedia feature matrices and a multimedia feature matrix set.

6. The robust multimedia recommendation method of claim 1, wherein the multimedia content data corresponds to a plurality of specific modals; and
the step of constructing the item association matrix based on the multimedia content feature comprises:
analyzing a similarity of the plurality of specific modals; and determining a plurality of similarity matrices corresponding to the plurality of specific modals and a similarity matrix set;
sparsifying and sorting the plurality of similarity matrices to obtain a target sequence in which a plurality of elements are sequentially arranged in a descending order; and
selecting first n elements from the target sequence to determine the item association matrix among a plurality of items and an association matrix set, wherein n is a predetermined value.

7. The robust multimedia recommendation method of claim 1, wherein after constructing the item association matrix based on the multimedia content feature, the robust multimedia recommendation method further comprises:
determining the user-item interaction matrix as a first matrix subset, and transposing the first matrix subset to obtain a second matrix subset;
determining the item association matrix as a third matrix subset;
constructing a first representation propagation matrix based on the first matrix subset, the second matrix subset, and the third matrix subset.

8. The robust multimedia recommendation method of claim 7, wherein after constructing the first representation propagation matrix, the robust multimedia recommendation method further comprises:
calculating a degree matrix of the first representation propagation matrix; and
normalizing the first representation propagation matrix by multiplying the first representation propagation matrix by the degree matrix to obtain a second representation propagation matrix.

9. The robust multimedia recommendation method of claim 8, wherein the step of learning the user representation matrix and the item representation matrix based on the deep graph neural model comprises:
randomly generating an initialized user representation matrix and an initialized item co-representation matrix via Gaussian distribution;
computing a multimedia content representation matrix of the item by using a predetermined multilayer perceptron;
fusing the initialized item co-representation matrix with the multimedia content representation matrix to determine the item representation matrix;
fusing the initialized user representation matrix with the item representation matrix to determine a 0^{th}-layer node representation matrix;
inputting the 0^{th}-layer node representation matrix into a predetermined graph neural network, and taking the second representation propagation matrix as an iterative coefficient to obtain a plurality of intermediate node representation matrices respectively corresponding to a plurality of convolutional layers in the predetermined graph neural network;
based on the number of the plurality of convolutional layers in the predetermined graph neural network, aggregating the plurality of intermediate node representation matrices and the 0^{th}-layer node representation matrix to obtain a final node representation matrix.

10. The robust multimedia recommendation method of claim 9, wherein the final node representation matrix H is expressed as
$$H = \frac{1}{L + 1} {\sum }_{l = 0}^{L} {H}^{l} ; \qquad ( 15 )$$
wherein L is the number of the plurality of convolutional layers; l represents a current convolutional layer; and H^{l} represents a node representation matrix of a l-th convolutional layer.

11. The robust multimedia recommendation method of claim 9, wherein after obtaining the final node representation matrix, the robust multimedia recommendation method further comprises:
analyzing and extracting individual row vectors in the final node representation matrix to determine a final user representation matrix H^{u} and a final item representation matrix H^{v};
the final user representation matrix H^{u} is expressed as: H^{u}=H[: M]
wherein H[: M] represents 1-st to M-th rows of the final node representation matrix H; and
the final item representation matrix H^{v} is expressed as: H^{v}=H[M:];
wherein H[M:] represents (M+1)-th to (M+N)-th rows of the final node representation matrix H.

12. The robust multimedia recommendation method of claim 1, wherein the representation information of the multimedia content is a multimedia content representation matrix; and the first loss function is an information bottleneck loss function; and
the step of minimizing, based on the information bottleneck theory, mutual information between the multimedia content and the representation information of the multimedia content to compute the first loss function comprises:
performing dimensionality reduction on a multimedia feature matrix set using a PCA algorithm to obtain a dimensionality-reduced multimodal feature matrix; and
calculating, based on the information bottleneck theory, a Hilbert-Schmidt independence criterion between the dimensionality-reduced multimodal feature matrix and the multimedia content representation matrix to obtain the information bottleneck loss function.

13. The robust multimedia recommendation method of claim 12, wherein the information bottleneck loss function is expressed as:
$$L ( {θ}_{1} ) = {\sum }_{k = 1}^{K} HSIC ( {F}^{′ k} , {T}^{k} ) ; \qquad ( 16 )$$
wherein L(θ₁) represents the information bottleneck loss function; θ₁ represents a parameter corresponding to K multilayer perceptrons; HSIC(,) represents the Hilbert-Schmidt independence criterion; F′^{K} represents the dimensionality-reduced multimodal feature matrix; and T^{k} represents the multimedia content representation matrix.

14. The robust multimedia recommendation method of claim 11, wherein the second loss function is a reconstruction loss function; and
the step of reconstructing the interaction matrix based on the user representation matrix and the item representation matrix to compute the second loss function comprises:
processing the final user representation matrix and the final item representation matrix by using a predetermined sigmoid activation function; predicting an interaction probability of each user for the item to reconstruct the user-item interaction matrix; and
based on a plurality of predicted interaction probabilities and all parameters involved in reconstructing the user-item interaction matrix, calculating the reconstruction loss function.

15. The robust multimedia recommendation method of claim 14, wherein the heterogeneous data further comprises an item set; and the plurality of predicted interaction probabilities are expressed as:
$${r}_{a i}^{′} = δ ( {( {h}_{a}^{u} )}^{T} {h}_{i}^{v} ) ; \qquad ( 17 )$$
wherein rₐᵢ′ represents the predicted interaction probabilities; δ represents the sigmoid activation function; hₐ^{u} represents a transpose of a representation vector in an a-th row of the final user representation matrix H^{u}; and hᵢ^{v} represents a representation vector in an i-th row of the final item representation matrix H^{v};
the reconstruction loss function L(θ₂) is expressed as:
$$L ( {θ}_{2} ) = {\sum }_{a = 1}^{M} {\sum }_{( i , j ) ∈ {D}_{a}} ln δ ( {( {h}_{a}^{u} )}^{T} {h}_{j}^{v} - {( {h}_{a}^{u} )}^{T} {h}_{i}^{v} ) ; \qquad ( 18 )$$
wherein θ₂ represents the parameters involved in reconstructing the user-item interaction matrix and corresponds to the reconstruction loss function, and θ₂=[P, Q, θ₁]; P is the initialized user representation matrix; Q is the initialized item co-representation matrix; and θ₁ represents parameters corresponding to K multilayer perceptrons;
Dₐ represents all training data of the a-th user uₐ, and Dₐ={(i, j)|i∈Rₐ, j∈V−Rₐ}; Rₐ represents an interactive item set of the a-th user uₐ; V represents the item set; and hⱼ^{v} represents a vector in a j-th row of the final item representation matrix H^{v}.

16. The robust multimedia recommendation method of claim 1, wherein the first loss function is an information bottleneck loss function, and the second loss function is a reconstruction loss function; and
the step of combining the first loss function and the second loss function to perform multi-task learning to update parameters of the deep graph neural model until the deep graph neural model converges comprises:
establishing a multitask optimization objective function based on the information bottleneck loss function and the reconstruction loss function; wherein the multitask optimization objective function corresponds to to-be-optimized parameters;
solving the multitask optimization objective function by a gradient descent method to update the to-be-optimized parameters;
determining a corresponding parameter when the multitask optimization objective function converges to a minimum value, as an optimal parameter after updating the to-be-optimized parameters; and
based on the optimal parameter, separately predicting a target interaction probability of each user for the item to determine a target interaction matrix, so as to achieve item recommendation.

17. The robust multimedia recommendation method of claim 16, wherein the multitask optimization objective function is expressed as:
$$L ( θ ) = L ( {θ}_{1} ) + α L ( {θ}_{2} ) + β {‖ [ P , Q , ] ‖}^{2} ; \qquad ( 19 )$$
wherein θ=[P, Q, θ₂] represents the to-be-optimized parameters; P is an initialized user representation matrix; Q is an initialized item co-representation matrix; θ₂ represents all parameters corresponding to the reconstruction loss function; ∥[P, Q]∥² is a regularization term; and α and β are configured to regulate a weight of the reconstruction loss function and a weight of the regularization term, respectively;
the target interaction matrix is expressed as: R*={rₐᵢ*}_{M×N};
wherein rₐᵢ*=δ((hₐ^{u}*)^{T} hᵢ^{v}*); hₐ^{u}* represents a target representation vector of an a-th user uₐ; and hᵢ^{v}* represents a target representation vector of an i-th item vᵢ.

18. An electronic device, comprising:
a processor;
a memory; and
a program stored on the memory and configured to be run on the processor;
wherein the program is configured to be executed by the processor to implement the robust multimedia recommendation method of claim 1.

19. A non-transitory computer-readable storage medium, wherein the non-transitory computer-readable storage medium stores a program; and the program is configured to be executed by a processor to implement the robust multimedia recommendation method of claim 1.
